(19) United States
(12) Patent Application Publication
(10) Pub. No.: US 2011/0066476 A1
(43) Pub. Date: Mar. 17, 2011

(54) Business management assessment and consulting assistance system and associated method

(76) Inventor: Joseph Fernard Lewis, Great Falls, VA (US)

(21) Appl. No.: 12/585,442

(22) Filed: Sep. 15, 2009

(51) Int. Cl. G06Q 10/00; G06F 3/048; G06F 17/30

(52) U.S. Cl. 705/11; 715/771; 707/769; 705/7; 707/E17.014; 715/810

(57) ABSTRACT

The present invention is an automated system and method for managing the delivery of management knowledge and other resources. The invention includes the design of assessment instrument(s) based on affiliate/service provider objectives. Assessments include the evaluation and scoring on seven management practices. These practices and the Management Maturity Model (M3) are used to help users understand their business' or organization's maturity level. The system provides owners information from affiliates and other knowledge resource providers based on assessment results and other profile information. At different levels of access or subscription, the system assigns an advisor or consultant to a user. Advisors are provided access to assessment results and system-developed reports. The system provides the user questions to help describe the type of support needed. The advisor has access to the user's description of need and can provide a proposal for the user.

### BACKGROUND OF THE INVENTION

1. Field of the Invention

The present invention relates to systems and methods for assessing an organization's management maturity by evaluating its current management processes against a set of standards. These results are used to provide users access to knowledge and resources automatically by the system through the use of criteria based on the results of the assessment and profile questions. In addition, this invention provides other organizations who are interested in helping these business organizations with successful change understand how much is needed and were to target the need, therefore improving efficiency and effectiveness of resources. The system is implemented on a computer network including but not limited to a server and a number of remotely located computers or terminals from which users can access the server. One such implementation would include the system and method operating via the Internet or the World Wide Web. The server as well as the individual computers and/or terminals are appropriately programmed with the various software modules and components in order to implement the system at its various levels of subscription, as will be explained in more detail hereinbelow (see FIG. 5 for example).

2. Description of Related Art

Business organizations have to manage the complexity of various stakeholders and functions as they continue to grow or transition from one state to another to survive. The maturity of an organization's management practices is a key ingredient in making these changes successfully. Therefore, it is desirable to understand how a business organization measures up against these practices and to receive information about how to address areas of need which would improve the likelihood of success.

### SUMMARY OF THE INVENTION

The system and methods are intended for business owners and other organizations who seek to support business owners which are or need to experience change in their organization which will require an understanding of the management practices to be successful in the change process. The system and method of this invention in totality manage the assessment and assistance process for helping a large number of organizations with similar interests. The system and method include a design of assessment instruments through the use of a 5-point Likert scale across seven key management practices. These are described as the qualitative section of the on-line assessment. Each assessment instrument also includes the design of a qualitative section which seeks to understand other important information about the organization. The assistance of the user is managed through the system by matching the results of the on-line calculation of the set of responses in the quantitative responses, profile responses, and designations of location and industry to a criterion attached to each document in a library of resources. This approach provides users only the information needed based on these criteria. In addition, the system allows organizations to continue assistance to users by allowing them to request specific assistance at two different levels. All of this is done on-line and with the use of payment methods.

In at least one embodiment, the present invention is directed to a system for managing the delivery of management knowledge and other resources implemented on an appropriately programmed and configured computer network having at least one server computer and a plurality of remote user computers, the system comprising: a registration module for at least one of registering new users into the system and allowing access to current users of the system; an assessment data entry module for generating an interactive display to a user to present questions and to receive responses from the user; an assessment analysis module for generating an assessment based on the responses received from the user; an assessment display module for generating a display of assessment results to the user; and a resource collection module for collecting resource data for the user in response to the assessment results.

In another embodiment, the present invention is directed to a method for managing the delivery of management knowledge and other resources implemented on an appropriately programmed and configured computer network having at least one server computer and a plurality of remote user computers, the method comprising the steps of: registering new users into the system and allowing access to current users of the system; generating an interactive display to a user to present questions and to receive responses from the user; generating an assessment based on the responses received from the user; generating a display of assessment results to the user; and collecting resource data for the user in response to the assessment results.

### BRIEF DESCRIPTION OF THE DRAWINGS

FIG. 1 illustrates the BTG management assessment methodology which evaluates an organization's change desires against the capability and practices of management to support the change;

FIGS. 2A and 2B are flowcharts of the on-line system (BTGworks.com™) according to at least one embodiment of the present invention;

FIG. 3 is a screen shot of a bar chart showing the maturity level based on an assessment result as outputted by the system to be displayed to the user, according to at least one embodiment of the present invention; and

FIG. 4 is an example of an analysis of multiple organization's results from an Excel spreadsheet that had data exported from the system, according to at least one embodiment of the present invention.

FIG. 5 is an illustration of the relationships between the server, where the software is stored, and the various roles that the system manages interaction between, according to at least one embodiment of the present invention.

### BRIEF DESCRIPTION OF THE TABLES

Table 1 is a sample list of variable codes the system can use to search on as criteria for completing a search and identifying knowledge resources and querying other sources of information for the user.

Table 2 is an example of Boolean functions that can be used to create score criteria for the system to search through. These score criteria create the condition for that resource or other sources to be attached to so that the system will know what to select when matching against a user condition.

Table 3 is a description of the steps the system takes to calculate the assessment results in each of the management practice categories the user has completed an assessment.

### DETAIL DESCRIPTION OF THE PREFERRED EMBODIMENTS

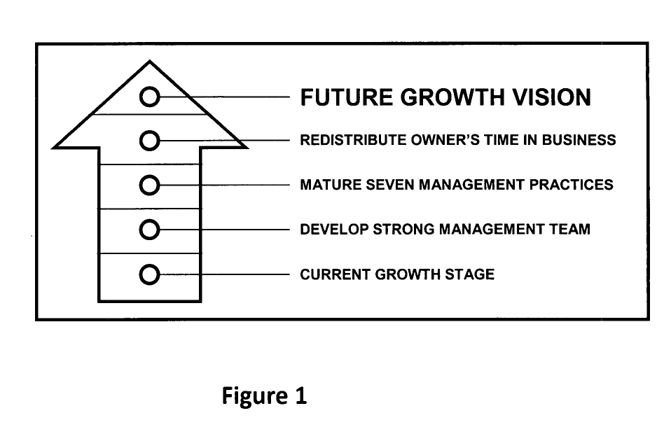

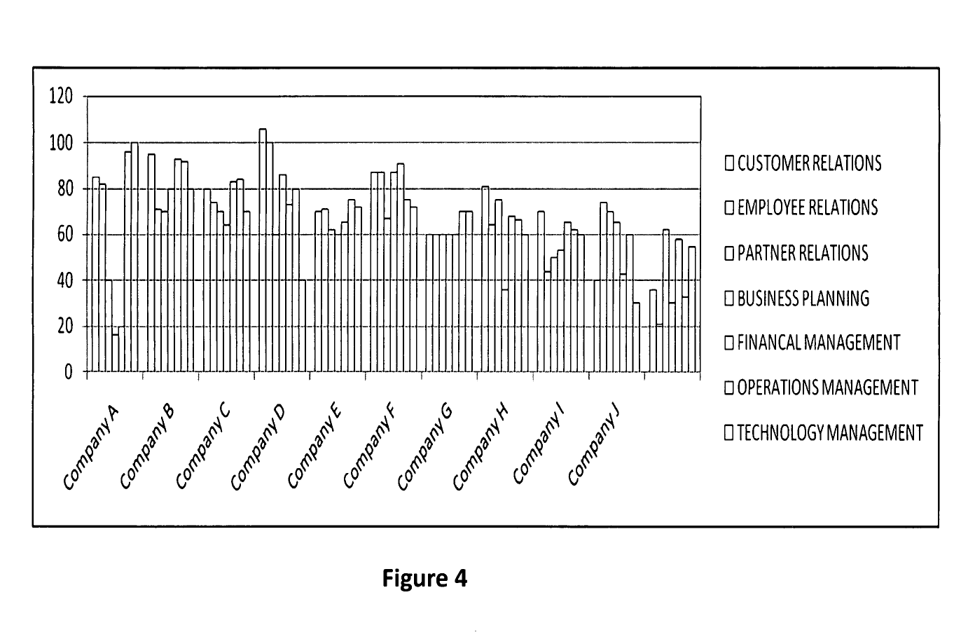

The description of the invention is presented by the use of FIGS. 1-4 presented herewith and as described above.

As shown in FIG. 1, the BTG management assessment methodology evaluates an organization's change desires against the capability and practices of management to support the change. The methodology is embedded in the invention as the approach used to assess and assist organizations. The method incorporates the evaluation of three elements: (1) an understanding of the strengths and weaknesses of the management team; (2) an evaluation of seven management practices; and (3) the distribution of time used by the owners of the organization. Together, these three elements provide a complete understanding of the management changes needed to improve on a successful change.

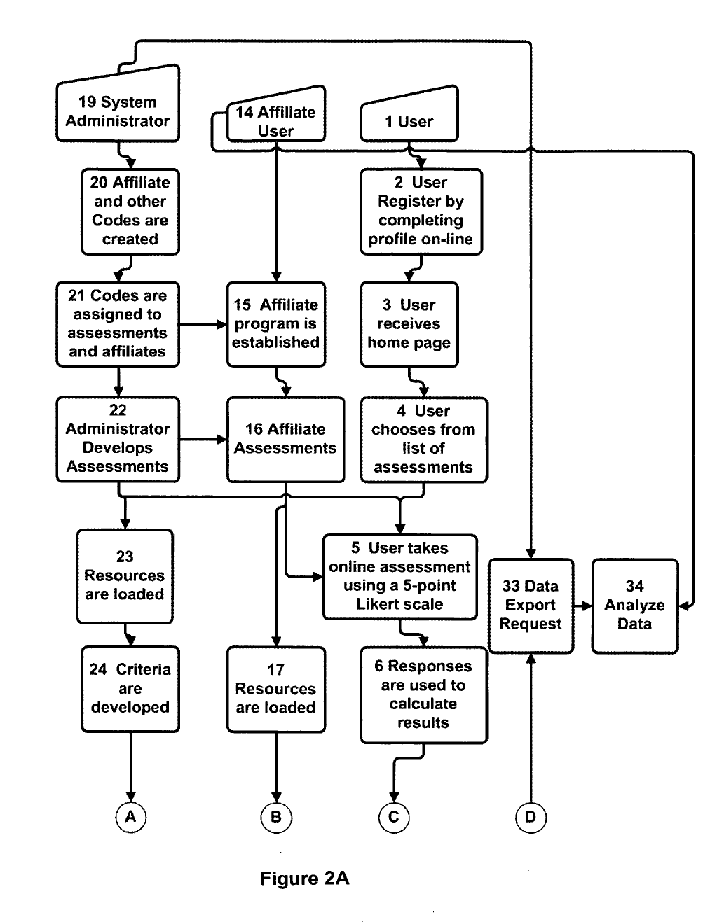

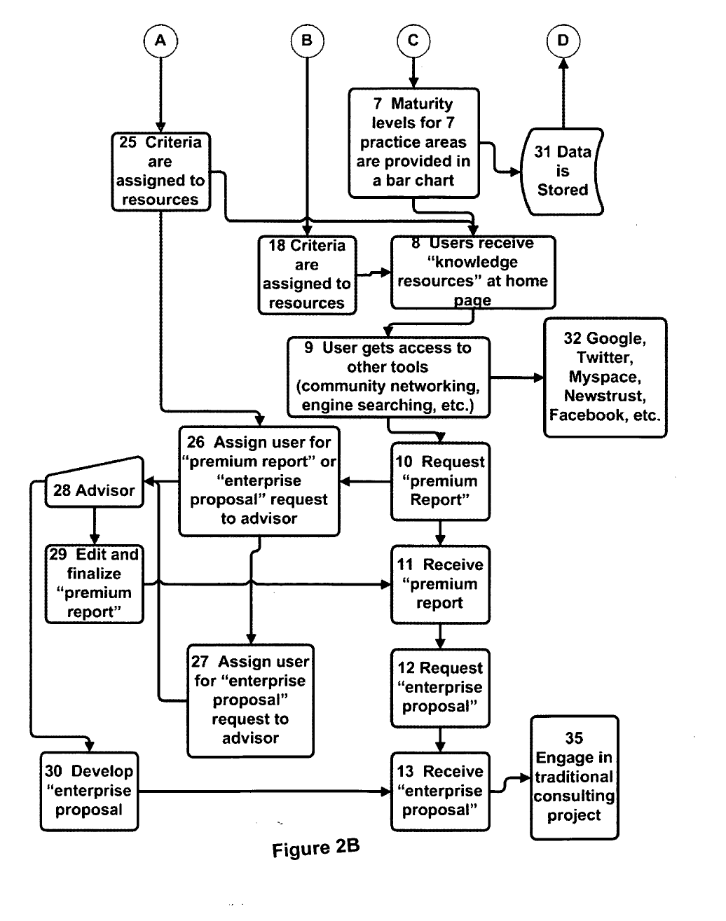

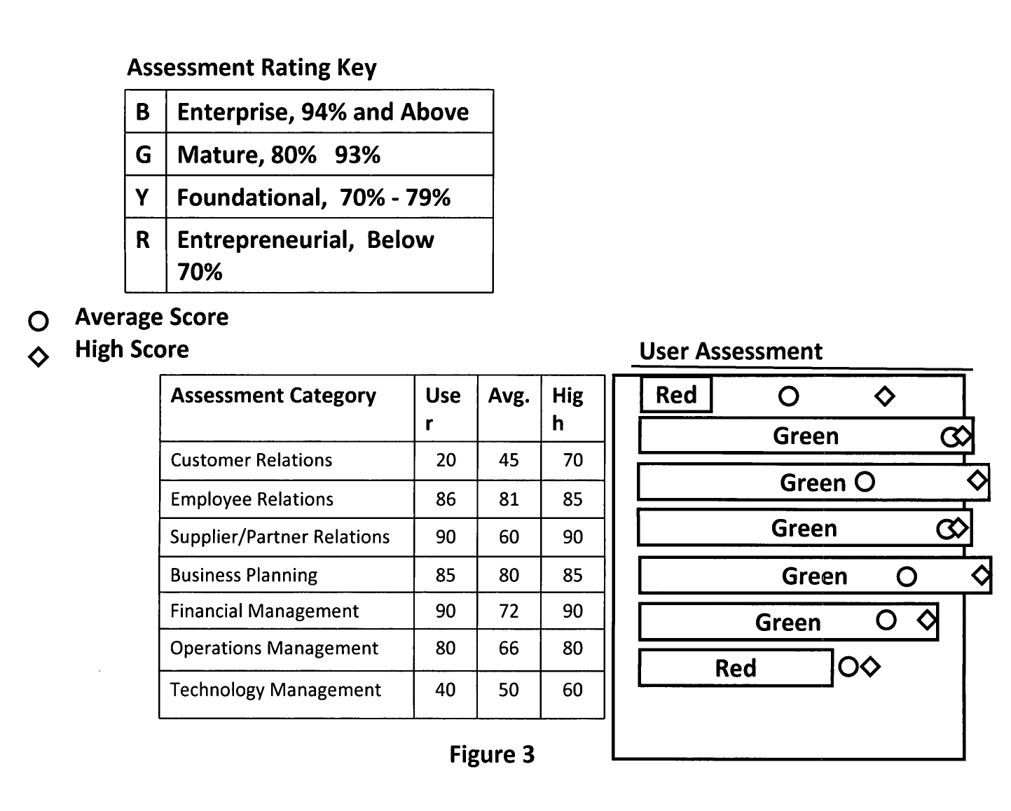

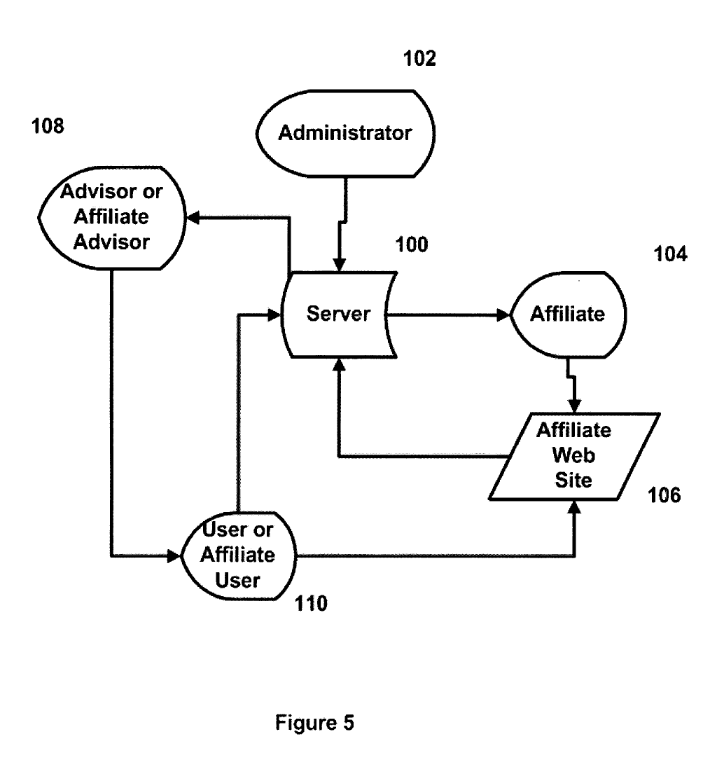

The invention as shown in FIGS. 2A and 2B incorporates the methodology of FIG. 1 for evaluating an organization's level of maturity, and management capability and practices to complete a desired change successfully. The invention embodies an on-line assessment by collecting information from users, using the responses to the assessment to calculate a result and presenting the results in a bar chart, as shown in FIG. 3, which identifies areas of need. The system then provides resources to the user automatically, at a password protected home page, which can be used to assist the user through its desired change. The invention provides these resources through the use of a code and criteria structure that allows the system to match the user's profile and assessment result information to resources that can address the user's needs. The system also allows the user to seek assistance by requesting more assistance through a plan or personal contact support. Using the same general approach and formulas, the invention can be designed to specific programs or industries and therefore leased or utilized by an unlimited number of affiliates and users. Upon request the system can then export the results and the data through the use of queries for analysis across a large group of users and across a large group of affiliates. The system allows the interaction of 4 user types: Administrator, Advisor, Affiliate and User (see FIG. 5).

The user starts with the system by registering. If the user is a member of an affiliate user they will receive an affiliate code (see “code structure” description) which is used in a number of ways. The user completes a profile page which requests basic information about the organization such as address, name, e-mail, etc. Different questions are presented at the profile page based on the type of membership affiliation.

Within the system, the code structure is used to perform in a number of capacities:
1. Associate a user with an affiliate—codes are created to identify affiliates. When a user registers with a certain affiliate code, the system provides that user its affiliate's logo at their home page so they will know they are assigned to that affiliate.
2. Provide a discount to a user—codes allow us to determine if the user should be charged a different price than the normal BTGworks.com price. This price can be free as well.
3. Control the display of resources—codes can be used in resource criteria to determine who should receive that resource.
4. Provide additional targeted assessments to a user—assessments can be assigned to a code so that assessment will only be available to users who have a matching code. This allows the dedicating of individual resources to affiliates and those users associated with that affiliate.
5. Allows follow-up questions to be added to the end of an assessment—Groups of questions can be created in the system and identified by name. Each group of questions can be assigned a code which in turn is identified in the assessment to distinguish which assessment receives which follow-up question group.

As noted above, the present invention is implemented on a computer network including but not limited to a server and a number of remotely located computers or terminals from which users can access the server. One such implementation would include the system and method operating via the Internet or the World Wide Web. The server as well as the individual computers and/or terminals are appropriately programmed with the various software modules and components of the present invention in order to implement the system at its various levels of subscription.

FIG. 5 is an illustration of the above-noted implementation showing the relationships between the server, where the software is stored, and the various roles that the system manages interaction between, according to at least one embodiment of the present invention. As shown, the present invention is generally implemented in a server 100 that is accessed by an administrator 102, an affiliate 104, an advisor 108 and a user 110. As will be explained in further detail hereinbelow, the administrator 102 accesses the server 100 to provide all the back-end data in the tool (i.e. inputs the assessment questions, establishes the criteria for resources, develop codes for affiliates, set-up affiliate, advisor and user profiles, and updates content on the web site). Affiliates 104 use the system to view and manage their affiliate members (users) and can also use the system to assign and manage affiliate advisors. Affiliates may have their own resources and databases that maybe made available on their website 106 through the system. The advisors 108 use the system to view assessment results and prescribe resources, reports and proposals to users 110. The users 110 interface with the system server 100 to take assessments, receive knowledge and other resources, and request reports and request other consulting assistance. As noted above, users 100 may also access affiliate websites 106 if such access if given to the user depending on their relationship to the affiliate and/or their level of subscription.

FIGS. 2A and 2B illustrate one embodiment of the present invention as implemented on a computer network, as an example, wherein the present invention implements the following steps, operations and functionalities: at Step (1), users first interacts with the system through a paid membership model. Each of the numbered steps, operations or functionalities represents the various software modules or components that make up the overall system of the present invention.

At Step (2), a user completes all fields on the registration screen or profile form, and then enters payment information. The system sends an email to the user, with an embedded registration link. The user clicks on the link, is redirected to login screen, and enters username and password. After completing the payment screen (if applicable) and the profile page, the user receives a password protected home page generated just for that user.

At Step (3), the user's password protected home page is where the system will send the user every time the user signs on with the appropriate username and password. If the user forgets the password, the user will be allowed to complete an email field and click a “forgot password” button. The system will reset the user's password with a randomized value, and send the new password to the user. The user can then log in with the new password, and may reset the password in a profile form at any time.

After completing the information input, the user can choose assessments by selecting industry and location information from pull down menus. The user's profile information, code, and industry and location selections allow the system to sort through all the loaded assessments and present to the user only those assessments meant for them.

At Step (4), the user selects an assessment from a matched list. If a user has registered with a code, this list will include assessments that match the industry/location combination, as well as assessment instruments that match the industry/location/code combination. The user clicks the ‘New Assessment’ button—the user may take a given assessment only at established intervals or only a certain number of times per time period, i.e. only once a year, as defined in the system code. An administrator may “push” an assessment instance to the user at any time. The user selects the applicable industry. The first drop-down generates the first three digits of the North American Industry Classification System (NIACS) code, while the second generates the last three. If no assessment matches the user's industry selection, an “Any Industry” assessment will be used. The user selects the applicable location. Only locations that match the user's industry selection are shown. If no matching locations are found, an “Any Location” option will be offered. The user selects assessment from a matched list. If a user has registered with a code, this list will include assessments that match the industry/location combination, as well as assessments that match the industry/location/code combination.

At Step (5), the user takes an assessment on line. The assessment can be done all at once or the user can stop and come back to complete the assessment at a later time. All assessments have questions in the seven management practice areas and will use a 5-point Likert scale.

At Step (6), the system performs a calculation based on the assessment question responses in each of the 7 management practice areas (see Table 3). Each question can be answered by selecting an answer that represents a value from 1 to 5. The number selected is stored in the system and is added to the answer numbers for each question in that section. The sum of that total is the raw score. That number is divided by the total number of questions in the section times 5. The result provides a raw percent for that section. Next, in any question in the other 6 sections that are assigned as a dependency (or that impacts this section), the response to that question is added or subtracted from this section's answer sum. That new number is divided by the total questions times 5, resulting in an overall percentage score. A percentage result is provided for each of the seven management practice areas.

As shown in FIG. 3, the system can then provide the user a display of the percentage results in a bar chart and numeric format. As note above, the results are provided based on a calculation from the responses to the quantitative questions. The user also receives a definition of the results. In addition to the user's results, the user can also be displayed an average score of all users who took the assessment and the highest score of all users. The displaying of the results also includes the assessment rating key which describes the 4 levels of maturity (as defined hereinbelow) as a part of the Management Maturity Method (M3™) form showing that an assessment has been completed. Internally, the system will also generate data for sending out periodic alert messages to the user when certain conditions have been met, such as; 2 months since last sign-in, or periodic updates for them to check-on in given intervals of time

At Step (7), these results are then displayed based on the methodology of the present invention that assigns a maturity level to each of the 7 management practice areas. In this embodiment, the maturity levels in each of the 7 management practice areas are displayed as bar graphs (see FIG. 3). As a part of the Management Maturity Method (M3™) of the present invention, these maturity levels are defined and measured as follows:

Enterprise, 94% and Above

Mature, 80%-93%

Foundational, 70%-79%

Entrepreneurial, Below 70%

At Step (31), after each assessment is completed and the data is calculated, the assessment results are stored in the system database to use for several purposes: matching up criteria definitions to the results to determine knowledge distribution, exporting data, and presenting the changes results associated with average and top scores.

At Step (8), based on the results of the assessment and the profile of the user the system performs a data mining function by searching through all resources loaded in the system by the administrator and identifies those resources' criteria that match the users unique profile and assessment results. The system then downloads the resources that match up with the user at the user's home page. This is done only after an assessment has been completed. This search is done every time the user does a sign-on, updates its profile data or receives a new set of results.

At Step (9), the user is given access to public and private networking and search engine tools via the network. The user selects the data sources to search and, if desired, a predefined query profile. Otherwise, the system will search on its own using the same process outlined in (8) above.

At Step (32), the system provides the user access and links to other tools for networking and researching purposes. The system will automatically query the user selected sources based on the user's assessment results and profile information, similarly to the query used to provide knowledge resources to the user from the system.

At Step (10), the user can request a premium report for any of the assessments taken. The user can do this by placing a check box next to the assessment to be upgraded, then click on the “Upgrade” button. Then the user completes payment fields and enters payment information (if applicable). The request is then communicated to an advisor who generates the report. While the advisor is developing the report, the user's display reads “Compiling Premium Report” and the “Premium Member” badge appears on the home screen.

At Step (11), when the system generates and outputs the Premium Report to the user, a clickable PDF00 link is populated in the user's assessment table. The Premium Report fee is charged only once, and no Automatic Recurring Billing (ARB) changes are made.

At Step (12), the user can request a proposal from an affiliate or the system. This is done by the user clicking on “Upgrade to Enterprise Edition!” button. Then the user completes data fields to describe the needs, and then clicks “Send” to submit request.

At Step (13), after the Advisor has published a proposal and cost, the offer will be presented to the user on the next login. The user has the option of accepting or declining the offer. If the user accepts, payment information will be completed and the Automatic Recurring Billing (ARB) amount will be modified. If the user declines the offer, the “Upgrade to Enterprise Edition!” button text changes to “Review Enterprise Offer.” The user may click this at any time, which will return to Step 3 (above). The users may also upgrade to an Enterprise membership, without first upgrading to a Premium Report.

At Step (14), an Affiliate is able to allow users to register and be associated with that Affiliate. When these users logon to the system, the Affiliate's logo is automatically inserted into the user's home screen.

At Step (15), an Affiliate accessing the system may log-on to the system to copy the Affiliate's link that may be included on a web site, manage the graphic file that will be used on their user's pages, and view associated users who have initiated an assessment. At the top of the Affiliate's work space is a URL that includes an embedded code. This URL may be included on the Affiliate's web page, so that visitors may be directed to the system's registration page after clicking the link. When a visitor is directed to the system's website from the Affiliate's workspace, the Affiliate Code is automatically pre-populated in the registration form. Affiliates may upload a graphical file, which will be included in the home page of all users who are associated with the affiliate. To upload a file, the affiliate user will click the “Choose File” button. Then browse to find the appropriate file on the local hard drive and upload the logo into the system. The logo file will not be saved in the system until the “upload” button is selected.

At Step (16), the users associated with a certain affiliate will see only those assessment instruments that are assigned to that affiliate. The bottom portion of the Affiliate's work space includes a table of all users who have initiated assessments. Using this interface, the Affiliate may easily ascertain the status of their associated user. In addition to seeing the user status the affiliate administrator will be able to see the user assessments as well.

At Step (17), a list of resources associated with the Affiliate is generated, with the ability to add other resources and assign access to any or all those resources to users who are associated with the affiliate. A resource may also be identified as an “opportunity”.

At Step (18), a classification of “score criteria” is available, called “private” which allows the Affiliate to assign selected criterion to resources they add. Affiliates will have the ability to create their own advisors, which will automatically be assigned to the affiliate. Affiliates will have the ability to assign advisors to customers in their affiliate group. Affiliates will have the ability to collect specific information from associated users through the “profile form”. Numeric answers are also used to construct “score criteria”. Affiliates are able to view their transactions (revenue-generating activities and payments made to them by the system).

At Step (19), the system administrator manages the system interfaces and controls on the all user types. The system administrator controls data export and site settings. They also upload new “Definition & Terms” PDFs and a new PDF files that will be used to provide users with information during an assessment. The uploaded files are automatically renamed “terms.pdf” by the system. The costs charged to members who register through the website is controlled and changed by the system administrator as well. All discounts will be applied against this number. On-screen messages that appear after registration are managed by the system administrator. Body text of the activation email that is sent to new users is also managed by the system administrator. Other controls by the system administrator include the following:
Text of the email that is sent to users who have submitted a “Forgot Password” request
Body text that appears on user's home screen
Body text that appears above users needs submission fields in Enterprise Request form
Body text that appears on the initial assessment screen
Body text that appears on the assessment summary screen

At Step (33), operation of the “Export Data” link will allow the system administrator to download a CSV file that contains selected data from the system. This file may be opened in, for example, Microsoft Excel for analysis. The CSV file is compiled in real-time as a result of a mySQL query. Clicking the “Export Database” link will allow the system administrator to download a mySQL file that contains all information in the database. This file may be used for back-up purposes, or to populate an off-line database. The mySQL file is not generated in real time, so that system stability can be assured. Instead, the file is automatically created each evening and stored on the server.

At Step (20), within the system administrator access, codes perform in a number of specific capacities. These capacities include the following:
a) Associate a user with an affiliate
b) Provide a discount to a user
c) Control the display of resources
d) Provide additional, targeted assessments to users by using affiliate designation through the establishment codes that are assigned to that affiliate.
e) Cause follow-up questions to be added to the end of an assessment. System allows the system administrator to define sets of questions that may be injected into the assessment process. These follow-up questions can be assigned to an assessment in two ways; (1) based on a user's response; and (2) based on an assigned code.

At Step (21), affiliate designation is established by using codes that are assigned to that affiliate.

At Step (22), the system administrator is the only user level that has the capability to develop assessment instruments in the system. They are presented with a table view of all assessments. The administrator can add new assessment questionnaires, and designate the Industry (NIACs code) type and Location (Metropolitan Statistical Area or MSA) type associated with that questionnaire. The system administrator may also develop an instructions page for each assessment developed.

The system administrator may also define “Growth Issues” wherein the administrator can edit/add/delete a growth issue, which are business issues a user is facing that are critical barriers to growth or change. Growth issues are displayed during the first stage of the user's assessment. The system administrator may generate a new group of follow-up questions to constitute another stage of the assessment.

The system administrator may also control “Qualitative” definitions of an assessment, by defining the question text for the first nine questions of the assessment, and the available answers. In operation, a portion of a user interface during an assessment contains a series of text boxes that allow the user to enter free-form text as part of a response. During a live assessment, a system administrator's screen will have a text box that will be rendered as a prompt that is accompanied by a line of text.

When the system administrator is accessing the “Qualitative” definitions, the administrator may edit/add/delete the quantitative questions that make up the bulk of the assessment tool. Each of the questions inputted as part of an assessment must be designed to be answerable on a Likert scale, with answers ranging from 1-5. Each question may be assigned up to two dependency categories, a follow-up group, and a portion of pre-formatted text that will be included in the user's Premium Report.

For example, questions can be stated as statements of actions that are being tested. The user must agree or disagree with these statements. As noted above, the questions will appear in seven different sections of the assessment, wherein the sections are driven by the 7 key management practice areas and several questions are required in every section for the assessment tool to work properly. The 7 areas are outlined below:
Customer Relations
Employee Relations
Partner Relations
Business Planning
Financial Management
Operations Management
Technology Management
   These seven areas are based on the M3™ methodology as shown in FIG. 1.

Dependent groups are questions or groups of questions relating to one management practice that are identified as having an integrated impact on at least one other management practice (or group or section). Dependent groups are defined by the system administrator such that, as discussed hereinabove, the calculation performed on the results for one management practice will be modified by the results of at least one another management practice. In addition, the system administrator can define a question to include text that will appear with the question to the user. The additional text can provide several uses; specifically, it can be used to further define the question or it can be used to describe an audit requirement to let the user know they need to be able to produce demonstrated proof to substantiate their response to the specific question.

As noted above, the default format for defining questions and their corresponding range of answers is the Likert 5 point scale. However, the administrator can also define the type of answer selections if the Likert 5 point scale is not appropriate or desired. The system administrator need only design the question(s) as needed and include the necessary description with the question(s) or with the entire assessment in order to convey the necessary instructions to the user, depending on the design of the assessment itself.

The system administrator may also design such questions to invoke a follow-up group of questions that will be presented if the user selects a specific answer to a question, or whenever the user answers a specific question in the assessment. The answering of such follow-up questions may also invoke the adding or generating of specific Report Text defined by the system administrator but added only to the results of an assessment under certain conditions. For example, added Report Text will be included in a user's Premium Report if such a report is requested and if a specific answer is submitted.

The system administrator may also tag questions and associate them with specific themes across the assessment. These tags will serve as another source of analysis for the administrator, advisors and affiliates to understand cross cutting issues which are not specific to a particular key management practice area, but important to that assessment objective. These tags will be used to calculate results similar to the key management practice areas. These themes will be used to identify result criteria for the system to distribute knowledge and other resources.

When a user selects an assessment from within the user home page, the system creates an “instance” of the assessment. An instance is a child element of an assessment, with associated user information. The master assessment is treated like a template file, with a unique copy created each time the user takes an assessment. The instance table may be used to easily see the status of instances that users have initiated.

At Step (23), files may be uploaded to the system's website and downloaded by a registered user. The system administrator may view available resources, by selecting a filter from a drop-down menu. Once a filter is selected, the resources that have a matching criteria assigned will be displayed in the table in the lower portion of the interface. To add a new resource to the system, the system administrator must input into the system the following fields as needed:
i) Title, which will be displayed in the user's home screen and on the purchase receipt
ii) Description, which will be displayed in the user's home screen to provide more information about the resource
iii) Cost, which will require the user to enter a valid credit card number before the resource is available.
iv) Score Criteria, which is a predefined criteria that will be used to selectively display the resource
v) Industry, if completed, the resource will appear for those users who have taken an assessment from the selected industry
vi) Location, if completed, the resource will appear for those users who have taken an assessment from the selected location.
vii) File, the uploaded resource file.

Resources can be for a fee, or with no charge. The display of these resources may be controlled by the assignment of score criteria. (Future) resources may be assigned “private or public” score criteria, assigned to specific users, marked as an “opportunity”, and associate the resource with multiple locations. “Public” resources may be assigned to one or more Affiliates, or made generally available for all users.

At Step (24) the administrator may create score criteria definitions that will be used to selectively display resources in the user's home screen. The descriptive title of the criteria set is an SQL statement using programmable arguments. Score Criteria are used to test against many elements to include those identified in Table 1.

At Step (25), the score criteria are assigned to resources to provide the system a way of identifying which resources to deliver to which user based on their results or profiles meeting the score criteria condition. Table 1 is a list of sample variable codes that the system administrator can use to develop score criteria. This criteria is developed by using Boolean functions such as those listed in Table 2. The combination of these codes and the Boolean functions create score criteria that the system uses when doing a search.

At Step (26), after a user requests a “premium report” the system lists that user with others on the system administrator's interface. The system administrator can then assign that user and others to advisors who are available to provide assistance.

At Step (27), after a user requests a “enterprise proposal” the system lists that user, with others, on the system administrator's interface, only if the user has not already been assigned. Otherwise, the system will send the request directly to the advisor to whom the user is assigned. The system administrator can then assign that user, and others, to advisors who are available to provide assistance.

At Step (28), the advisor interface consists of a series of tabs where each controls a specific piece of functionality within the system. Those tabs include: Workspace, Resources, The users, and Logout. The workspace tab is visible to the advisor after login. Through this portion of the interface, the advisor is able to easily see an overview of the actions that must be taken on a user's account. The workspace may include displaying a list of users who need a Premium Report to be created, while also listing users who have requested an Enterprise upgrade. All user names may be selected to open user details. Premium Report users would be opened separately, so that a system administrator or advisor, or anyone else conducting an analysis may work with multiple reports simultaneously.

At Step (29), when an advisor clicks a user's name associated with the “Pending report upgrades” portion of the workspace, the advisor will also be displayed “Results” and “Report” data relating to that user. The “Results” data provides the advisor with a synopsis of the user's performance on the assessment, including, for example, the user's results bar chart, a full report table, and a time comparison matrix, as well as a listing of all questions and responses from the assessment. The “Report” data presented to the advisor contains two text areas. The first is auto-populated with diagrams, tables, and “canned” report text. Some of these elements are included in the report, based on the answers that the user has selected during the assessment process. Basic HTML mark-up code and CSS 2.1 styling may be used to format the contents of the report. The second text area allows the advisor to enter case-specific notes, which will not be passed on to the user. After the advisor saves the report, it is available for preview. This will allow the advisor to ensure that the document is properly formatted. The report may be pushed to the user. Once published, the document will be made available in the user's homes screen assessment table.

At Step (30), after a user has submitted a request for an Enterprise account upgrade, the user's name will appear in the “Pending enterprise requests” portion of the advisor's workspace. The advisor may interface with the user by entering a proposal message for the user, as well as a new ARB amount. The revised ARB amount will not affect the start date of the ARB subscription. When the appropriate fields for generating the proposal have been completed and the “send” button clicked, the Upgrade offer will be sent to the user.

Steps (31)-(33) have been addressed earlier hereinabove.

At Step (34), operation of Step (33) to export data allows an Affiliate to access the database in order to conduct an analysis of the exported data.

At Step (35), in response to the user accepting an Enterprise account upgrade proposal, the owner/operator of the system can engage in a traditional consulting role for the user.

Although the present invention has been fully described in connection with the preferred embodiment thereof with reference to the accompanying drawings, it is to be noted that various changes and modifications will be apparent to those skilled in the art. For example, the present invention may be implemented using any operating system, programming language or database structure of appropriate complexity and maturity to accomplish all the necessary functionalities of the present invention, and is not necessarily limited to being implementable to any one such operating system, programming language or database structure. Such changes and modifications are to be understood as included within the scope of the present invention as defined by the appended claims, unless they depart therefrom.

TABLE 1

| Sample list of Code Variables | Example Usage |
|---|---|
| years_in_business | “years_in_business > 5” |
| org_size | “org_size > 100” |
| state | “state = ‘VA’ OR state = ‘MD’” |
| is_formal | “is_formal” |
| is_informal | “is_informal” |
| CR | “CR > 50 AND CR < 80” |
| ER | “ER > 50 AND ER < 80” |
| SR | “SR > 50 AND SR < 80” |
| BP | “BP > 50 AND BP < 80” |
| FM | “FM > 50 AND FM < 80” |
| OM | “OM > 50 AND OM < 80” |
| TM | “TM > 50 AND TM < 80” |
| reg_code | “reg_code = ‘10pctoff’” |
| grand_total | “grand_total > 90” |
| survey_name | “survey_name = ‘BTG Test’” |

TABLE 2

| Statement | Description |
|---|---|
| “AND” Logical, AND | Check whether a value is |
| “BETWEEN ... AND | within a range of values |
| “COALESCE( )” | Return the first non-NULL argument |
| “<=>” | NULL-safe equal to operator |
| “=” | Equal operator |
| “>=” | Greater than or equal operator |
| “>” | Greater than operator |
| “GREATEST( )” | Return the largest argument |
| “IN( )” | Check whether a value is within a set of |
| | values |
| “INTERVAL( )” | Return the index of the argument that |
| | is less than the first argument |
| “IS NOT NULL” | NOT NULL value test |
| “IS NOT” | Test a value against a Boolean |
| “IS NULL” | NULL value test |
| “IS” | Test a value against a boolean |
| “ISNULL( )” | Test whether the argument is NULL |
| “LEAST( )” | Return the smallest argument |
| “<=” | Less than or equal operator |
| “<” | Less than operator |
| “LIKE” | Simple pattern matching |
| “NOT BETWEEN ... AND ...” | Check whether a value is not within a |
| | range of values |
| “!=”, “<>” | Not equal operator |
| “NOT IN( )” | Check whether a value is not within a |
| | set of values |
| “NOT LIKE” | Negation of simple pattern matching |
| “OR” | Logical OR |

TABLE 3

| Calculation Description | | Example | Result |
|---|---|---|---|
| 1) | Total Number of Questions | 7 | Customer Relations Section |
| 2) | Highest Numerical possible score within | 5 | 1 to 5 scale |
| | Section | | |
| 3) | 2 Dependency questions in other sections | 2 question in Employee | Response to these questions |
| | (optional) | Relations Section | in other sections will have |
| | | 3 question in Business | impact on score in Customer |
| | | Planning Section | relations section |
| 4) | 1) × 2) | 7 × 5 = 35 | Section Baseline |
| 5) | User response to first 3 questions is a 2 | 3 × 2 = 6 | User Raw Score for Customer |
| | and the next 3 questions is a 4 and the | 3 × 4 = 12 | Relations Section |
| | final question is a 5 | 1 × 5 = 5 | |
| | | Total = 23 | |
| 6) | 5)/4) | 23/35 = 0.6571 | User Raw Percentage for |
| | | | Customer Relations is 65.71% |
| 7) | Employee Relations Dependency | | |
| | questions were answered with a 5 and 4. | | |
| 8) | Business Planning Dependency question | | |
| | was answered with a 2, 5, and 3 | | |
| 9) | Employee Relations Dependency impact | +2, +1 | Impact s are assigned as: |
| | | | +2 for a 5 response |
| | | | +1 for a 4 response |
| | | | 0 for a 3 response |
| | | | −1 for a 2 response |
| | | | −2 for a 1 response |
| 10) | Business Planning Dependency impact | −1, +2, 0 | Same as above |
| 11) | 5) + 9) + 10) | 23 + 2 + 1 − 1 + 2 + 0 = 27 | Overall Score for Customer |
| | | | Relations Section |
| 12) | 11)/4) | 27/35 = 0.7714 | Customer Relations Section |
| | | | overall Percentage is 77.14% |

I claim:

1. A system for managing the delivery of management knowledge and other resources implemented on an appropriately programmed and configured computer network having at least one server computer and a plurality of remote user computers, the system comprising:
a registration module for at least one of registering new users into the system and allowing access to current users of the system;
an assessment data entry module for generating an interactive display to a user to present questions and to receive responses from the user;
an assessment analysis module for generating an assessment based on the responses received from the user;
an assessment display module for generating a display of assessment results to the user; and
a resource collection module for collecting resource data for the user in response to the assessment results.

2. A system for managing the delivery of management knowledge and other resources according to claim 1, wherein the assessment data entry module is configured to provide a selection of a plurality of assessments for the user.

3. A system for managing the delivery of management knowledge and other resources according to claim 1, wherein the assessment analysis module is configured to calculate a plurality of assessment result values in response to numerical value responses received from the user.

4. A system for managing the delivery of management knowledge and other resources according to claim 1, wherein the assessment display module is configured to generate a graphical representation of the assessment generated by the assessment analysis module.

5. A system for managing the delivery of management knowledge and other resources according to claim 4, wherein the assessment display module is configured to generate a graphical representation of each of the a plurality of assessment result values generated by the assessment analysis module.

6. A system for managing the delivery of management knowledge and other resources according to claim 1, wherein the resource collection module is configured to search database resources stored in the server, and provide access to selected data from said database resources to the user.

7. A system for managing the delivery of management knowledge and other resources according to claim 1, wherein the resource collection module is configured to search affiliate database resources accessible to the system from an affiliate service, and provide access to selected data from said affiliate database resources to a user associated with said affiliate service.

8. A system for managing the delivery of management knowledge and other resources according to claim 1, wherein the resource collection module is configured to provide the user access to at least publicly available database resources in response to the assessment results.

9. A system for managing the delivery of management knowledge and other resources according to claim 1, further comprising:
an assessment generating module accessible only to administrator users for defining at least a first assessment structure of questions and responses, the first assessment structure forming an assessment presented to a user via operation of the assessment data entry module.

10. A system for managing the delivery of management knowledge and other resources according to claim 9, wherein the assessment generating module is further configured for administrator users to define a follow-up assessment structure of questions and responses connected to the first assessment structure that are presented to the user via operation of the assessment data entry module in response to operation of predetermined questions or answers from the first assessment structure.

11. A system for managing the delivery of management knowledge and other resources according to claim 1, wherein the registration module is configured to generate a user-specific homepage so as to display at least one of user-specific assessments and user-specific data in conjunction with the assessment data entry module generating the interactive display.

12. A method for managing the delivery of management knowledge and other resources implemented on an appropriately programmed and configured computer network having at least one server computer and a plurality of remote user computers, the method comprising the steps of:
registering new users into the system and allowing access to current users of the system;
generating an interactive display to a user to present questions and to receive responses from the user;
generating an assessment based on the responses received from the user;
generating a display of assessment results to the user; and
collecting resource data for the user in response to the assessment results.

13. A method for managing the delivery of management knowledge and other resources according to claim 12, wherein the step of generating an interactive display to the user includes displaying a selection of a plurality of assessments for the user.

14. A method for managing the delivery of management knowledge and other resources according to claim 12, wherein the step of generating the assessment includes calculating a plurality of assessment result values in response to numerical value responses received from the user.

15. A method for managing the delivery of management knowledge and other resources according to claim 12, wherein the step of generating the display of the assessment results includes generating a graphical representation of the assessment results.

16. A method for managing the delivery of management knowledge and other resources according to claim 15, wherein the step of generating the display of the assessment results includes generating a graphical representation of each of the a plurality of assessment result values generated by the assessment analysis module.

17. A method for managing the delivery of management knowledge and other resources according to claim 12, wherein the step of collecting resource data includes searching database resources stored in the server, and providing access to selected data from said database resources to the user.

18. A method for managing the delivery of management knowledge and other resources according to claim 12, wherein the step of collecting resource data includes searching affiliate database resources accessible to the system from an affiliate service, and providing access to selected data from said affiliate database resources to a user associated with said affiliate service.

19. A method for managing the delivery of management knowledge and other resources according to claim 12, wherein the step of collecting resource data includes providing the user access to at least publicly available database resources in response to the assessment results.

20. A method for managing the delivery of management knowledge and other resources according to claim 12, further comprising the step of:
generating assessments to be presented to users, including the steps of providing limited access only to administrator users and using said limited access for defining at least a first assessment structure of questions and responses.

21. A method for managing the delivery of management knowledge and other resources according to claim 20, wherein the step of generating assessments to be presented to users further includes defining a follow-up assessment structure of questions and responses connected to the first assessment structure that are presented to the user via operation of the assessment data entry module in response to operation of predetermined questions or answers from the first assessment structure.

22. A method for managing the delivery of management knowledge and other resources according to claim 12, wherein the step of registering new users into the system and allowing access to current users of the system includes generating a user-specific homepage so as to display at least one of user-specific assessments and user-specific data in conjunction with the step of generating the interactive display.
